(19) United States
(12) Patent Application Publication
(10) Pub. No.: US 2009/0140505 A1
(43) Pub. Date: Jun. 4, 2009

(54) Shopping Cart Security Device

(76) Inventors: Don T. Fryer, San Diego, CA (US); Jenna Lake, Solana Beach, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 12/324,479

(22) Filed: Nov. 26, 2008

Related U.S. Application Data
(60) Provisional application No. 60/992,004, filed on Dec. 3, 2007.

(51) Int. Cl. B62D 39/00

(52) U.S. Cl. 280/33.994

(57) ABSTRACT

A device and method for temporarily maintaining and securing valuables in a shopping cart is disclosed. The device is manufactured to fit in the upper basket area of standard shopping carts. The device can be modified to fit in alternative shopping cart designs and sizes. The device is generally manufactured from a flat panel which forms a lid enclosure over the small basket of a shopping cart. The device is secured to the back side of a shopping cart basket and can flip up so that valuables may be stored inside the small basket. The device is then flipped down and is secured in the front of the small basket of the cart nearest to the shopper.

### RELATED APPLICATIONS

This application claims the priority of U.S. Provisional Application No. 60/992,004 filed Dec. 3, 2007, which is incorporated herein by reference in its entirety.

### FIELD OF THE INVENTION

The present invention relates, in general, to a device which improves the security and functionality of grocery and retail store shopping carts. More particularly, the present invention relates to a device designed to completely enclose the top basket of a shopping cart and prevent the theft of purses or other valuable items stored temporarily by a customer using the cart. Additionally this device can be constructed to hold coupons, cell phone, car keys or miscellaneous items for customer convenience and may be imprinted with the store or third-party ancillary advertising. When not in use, the device stores neatly away so that a consumer may use the top basket for other purposes.

### BACKGROUND OF THE INVENTION

Traditional shopping carts are designed with a standard top basket equipped to hold grocery items and customers' purse or other valuables. Unfortunately, these retail carts do not offer any security for the valuables or purses stored in the top basket. Consumers who divert their eyes from their cart or turn around to select an item from the shelf risk having their valuables snatched in a split second. Currently there is no device to adequately secure shoppers' purses or other valuable items so they are forced to carry their belongings in a cumbersome manner. The necessity for keeping one's eyes and hands on their valuables at all times decreases shopping efficiency and distracts from the chore at hand. There is a need to resolve this problem by employing a method and designing a device which provides security for shoppers' valuables during the time they are in the store so their hands (and attention) are free to shop. This device alleviates concerns that shoppers' valuables are in jeopardy when their attention is diverted or focused elsewhere.

### SUMMARY OF THE INVENTION

This invention involves a device and method for securing valuables in a shopping cart. The device is manufactured to fit in the upper basket area of standard shopping carts. The device can be modified to fit in alternative shopping cart designs and sizes. The device is generally manufactured from a flat panel which forms a lid enclosure over the small basket of a shopping cart. The device is secured to the back side of a shopping cart basket and can flip up so that valuables may be stored inside the small basket. The device is then flipped down and is secured in the front of the small basket of the cart nearest to the shopper. This device can be easily installed and removed from shopping carts so that the store or manufacturer of the shopping cart may replace, remove, or exchange the device. This device may be flipped over the back of the top cart when not in use so that shoppers have access to the basket for storage of groceries or other uses (seating of children, etc.). Upon completion of the consumer's shopping trip, the cart is returned to the store and stacked in a bay with other shopping carts. When not in use, the device lays flat against the back of the basket, thereby allowing for carts to nest one on top of the other. This device may be retrofitted to existing carts or manufactured on new carts at the time of construction.

In alternative embodiments the device can further be equipped with various cut-outs that provide storage space on top while securing items below, e.g., cell phone holder, coupon holders, key storage, etc. Either the store or other product manufacturers may place advertising media on the security device for viewing by the customers. As determined by the cart manufacturer's specifications, the device may be attached to the backside of the shopping carts' top basket by means of free-moving brackets and latches. The attachment means can be via nylon webbing with plastic closures or alternative materials which are flexible and unbreakable.

### BRIEF DESCRIPTION OF THE DRAWINGS

The accompanying drawings, which are incorporated in and constitute a part of the specification, illustrate embodiments of the invention, and together with the description, serve to explain the objects, advantages, and principles of the invention. In the drawings:

FIG. 1 is a perspective view of the back half of a shopping cart with an embodiment of the shopping cart security device installed;

FIG. 2 is a perspective view of an embodiment of the shopping cart security device;

FIG. 3 is a view looking from the back of a shopping cart with a shopping cart security device installed; and

FIG. 4 is an alternative embodiment of the device configured to hold coupons, a cell phone, keys, and to display advertising.

### DETAILED DESCRIPTION OF PREFERRED EMBODIMENTS

After reading this description it will become apparent to one skilled in the art how to implement the invention in various alternative embodiments and alternative applications. However, all the various embodiments of the present invention will be described herein, it is understood that these embodiments are presented by way of an example only, and not limitation. As such, this detailed description of various alternative embodiments should not be construed to limit the scope or breadth of the present invention as set forth below.

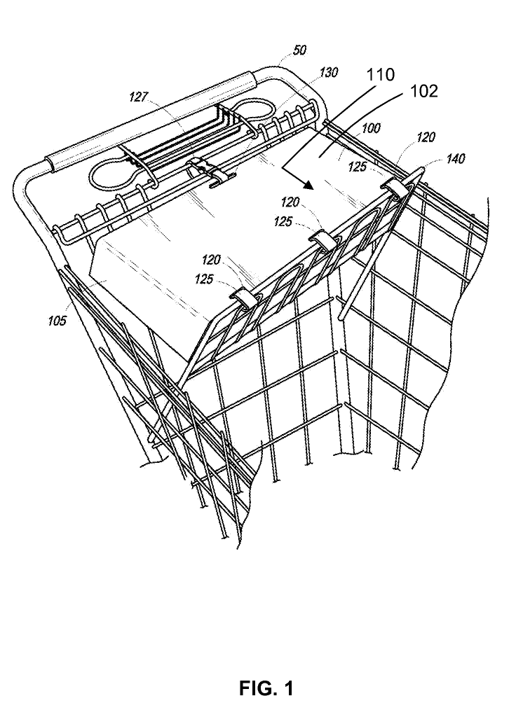

With reference to FIG. 1 an embodiment of the shopping cart security device 100 is seen installed in a standard shopping cart 50. The security device 100 works to create an enclosure in the top basket of shopping carts so that valuables can be stored inside this area. Shoppers utilizing device 100 are able to turn briefly their backs to the cart without having to worry their valuables will be stolen.

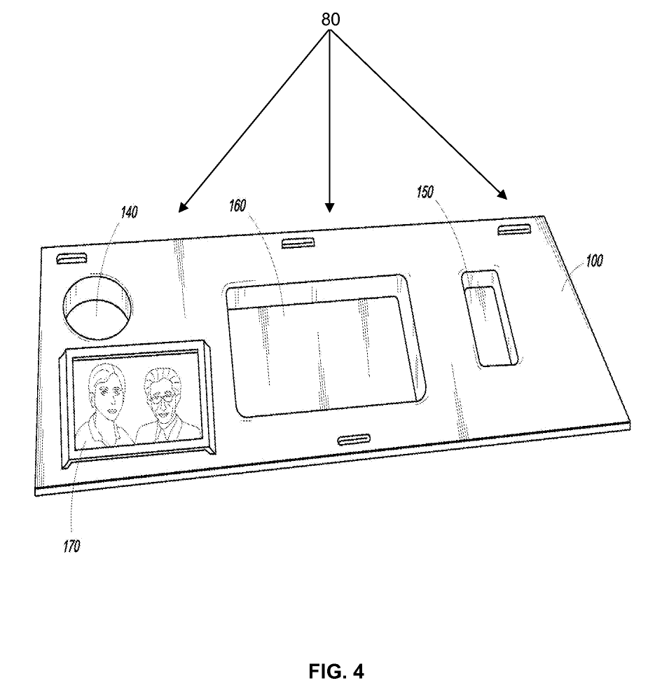

The security device 100 fits into the top small basket 70 of shopping cart 50. The device 100 is made of plastic or other durable substance. Device 100 is generally rectangular and includes a panel 110 having a top surface 102, a bottom surface 104, and two thin sides 106a, 106b. Thin side 106a is proximate to front end 100a and thin side 106b is proximate to back end 100b. Device 100 is economical to manufacture and as a result of this benefit can be easily custom manufactured for a particular store or product producer to incorporate specific advertising. In one embodiment, device 100 contains one or more pockets 80 on top surface 102 to hold coupons, cell phones, car keys, and/or a shopping list. In another embodiment the device 100 can be manufactured to display advertising (numeral 170 in FIG. 4.) In an alternative embodiment the device 100 can have cutout holders, storage, and advertising on top surface 102.

Referring to FIG. 1 the device 100 covers the entire small basket 70 and has flaps 105 extending downward at an angle on each side to enclose the small basket 70 so that thieves' hands cannot reach items enclosed by the device 100. In a preferred embodiment, flaps 105 extend continuously from and are part of device 100, such that flaps 105 include top surface 102, bottom surface 104. The extensions 105 are flat, longer pieces of the hard substance which flare out at an angle and sit proximate to the sides of the shopping basket so that there is not enough space for somebody to reach inside the small basket 70 and grab the valuables inside. In some embodiments, extensions 105 sit within centimeters of the sides of the shopping basket.

In a preferred embodiment the device 100 is retrofitted to the shopping cart 50 via one or more brackets or straps 125. In FIG. 1 there are three attachment openings or holes 120 shown to the back of the small basket 70. In this embodiment the attachments are made by webbing 125 such as nylon webbing, which feed through holes 120 in the device 100 and around the top wire 140 of the basket 70. In a preferred embodiment, webbing 125 forms a loop through attachment holes 120. The ends of the webbing 125 are secured under the device 100 within the small basket 70 with a fastener such as a clamp 127. While a clamp 127 is shown, it should be understood that any other fastening means may be used to secure webbing 125 to small basket 70. In a preferred embodiment, the clamp 127 cannot be reached when the device 100 is closed so that it cannot be freely opened by a thief. The front end 100a of device 100 has one or more holes 130 through which another piece of webbing or other type of non-breakable rope, cord, chain or cable 125 is fed. The webbing 125 is fed through the hole 130 and around the top bar 52 of the shopping cart 50. On either end of the cord, cable or webbing 125 there is clamp 127. The clamp 127 can be manufactured from plastic, metal or other hard substance and allows the two ends of the webbing 125 or other cord or rope to be secured together. In order to assure that a potential thief does not unclamp the clamp, the user can slide the webbing 125 so that the clamp 127 is underneath the device 100 within the small basket 70 and is not easily or quickly accessible to open or release.

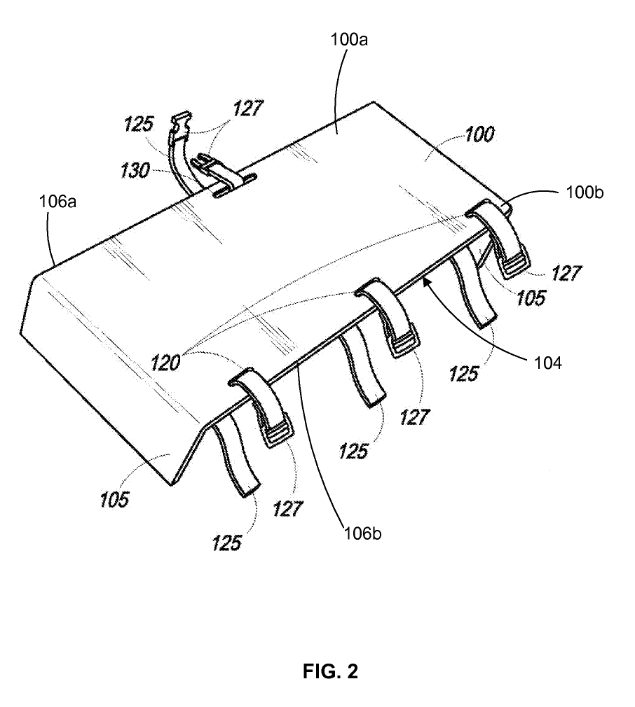

Referring to FIG. 2, a perspective view of an embodiment of the shopping cart security device 100 is displayed. In viewing the device 100, the flaps 105 can be seen extending downward at an angle and being continuous with the device 100 at either end. In an alternate embodiment, the device 100 can be manufactured without flaps 105. In the embodiment without flaps 105, the edges of the device 100 cover the entire opening of the small basket 70. In the embodiment displayed in FIG. 2 there are three holes 120 for attachment to the back of the small basket 70 of the shopping cart 50. The nylon webbing or other cord 125 is fed through these holes 120. There is a buckle 127 at one end of the cord 125 so that the webbing can be wrapped around the bars of the shopping cart and then attached to itself underneath the device 100. At the front end 100a of device 100 there is one or more holes 130 through which the webbing or cord 125 passes. In a preferred embodiment, there is a detachable clip 127 with either end of the clip 127 attached to each end of the cord 125. In order to fasten the device closed the user will snap the ends of the cord or webbing 125 together at the clip 127 and then can slide the cord 125 so that the connected clamp 127 is facing downward underneath the device 100.

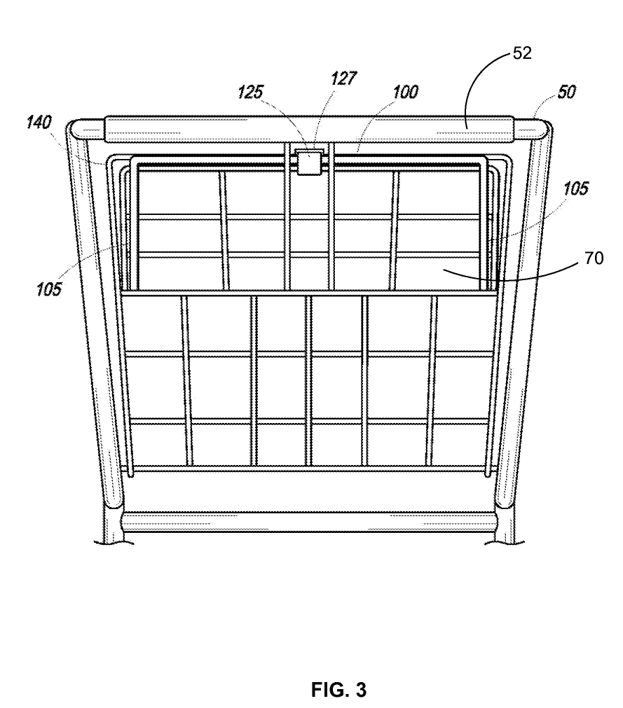

Referring to FIG. 3, the device 100 is seen from looking at the back of the shopping cart 50. In FIG. 3, the device 100 is securely fastened shut and the clamp 127 at the front end 100a of the device 100 is seen underneath the device 100 within the small cart 70. The attachment to the front end 100a of the shopping cart 50 with the nylon cording 125 can be seen at this angle.

With reference to FIG. 4 an embodiment of the device configured to hold coupons, a cell phone, keys, cups and present advertisements is shown. A cup holder 140 allows the user to place their coffee or other drink in the shopping cart 50 while shopping. A cell phone holder 150 allows a user to place their cell phone on top surface 102 of the device 100 so they do not have to unlock the device 100 to reach into their purse to get their cell phone if it started ringing during their shopping expedition. A coupon holder 160 placed on top surface 102 of the device 100 allows a user to place their coupon file/holder, car keys, or miscellaneous items in accessible place while they are shopping. Framed advertisements or embedded advertisements 170 on the device 100 allow either the store or the manufacturer of products to advertise their products directly to the consumer. In some embodiments, the advertiser may either purchase advertising space from the grocery store or directly from the manufacturer of the device.

The above description of disclosed embodiments is provided to enable any person skilled in the art to make or use the invention. Various modifications to the embodiments will be readily apparent to those skilled in the art; the generic principals defined herein can be applied to other embodiments without departing from spirit or scope of the invention. Thus, the invention is not intended to be limited to the embodiments shown herein but is to be accorded the widest scope consistent with the principals and novel features disclosed herein.

What is claimed is:

1. A shopping cart security device configured to create a secure enclosure in the top basket of a shopping cart comprising:
a panel having a top surface and bottom surface;
a first fastening means for securing the panel to the shopping cart, wherein the first fastening means is not easily accessible to open;
a second fastening means for securing the panel to the shopping cart, wherein the second fastening means is accessible to open; and
wherein the panel is disposed within the top basket of the shopping cart such that the panel forms an enclosure within the top basket of the cart, the bottom surface of the panel being located within the enclosure and the top surface of the panel being external to the enclosure.

2. The device according to claim 1, wherein the panel includes a plurality of openings for receiving the first and second fastening means.

3. The device according to claim 2, wherein a cord forms a loop though each of the plurality of openings in the panel.

4. The device according to claim 3 wherein the cord is selected from the group consisting of webbing, rope, chain and cable.

5. The device according to claim 3, wherein the first and second fastening means are attached to the cords.

6. The device according to claim 1, wherein the first and second fastening means comprise clamps.

7. The device according to claim 6, wherein the clamps are fabricated from a material consisting of plastic and metal.

8. The device according to claim 1, wherein the panel includes a plurality of flaps.

9. The device according to claim 8, wherein the flaps extend downward at angle such that the top surface of the flaps is proximate to an inner surface of the top basket of the shopping cart.

10. The device according to claim 9, wherein the panel having a plurality of flaps forms a full enclosure within the top basket of the cart.

11. The device according to claim 1, wherein the top surface of the panel includes a recess for holding a cup.

12. The device according to claim 1, wherein the top surface of the panel includes a recess for holding a cell phone.

13. The device according to claim 1, wherein the top surface of the panel includes a recess for holding coupons.

14. The device according to claim 1, wherein the top surface of the panel includes a recess for holding keys.

15. The device according to claim 1, wherein the top surface of the panel includes an area configured to display advertisements.

16. The device according to claim 15, wherein the area configured to display advertisements is recessed.

17. The device according to claim 1, wherein when the shopping cart is not in use, the shopping cart security device is configured to lay flat against the top basket of the shopping cart so that the cart may be stacked with other carts.

18. A shopping cart security system comprising:
a shopping cart having a top basket area and a main basket area; and
a security device configured to create a secure enclosure in the top basket area of the shopping cart comprising:
a panel having a top surface and bottom surface;
a first fastening means for securing the panel to the shopping cart, wherein the first fastening means is not easily accessible to open;
a second fastening means for securing the panel to the shopping cart, wherein the second fastening means is accessible to open; and
wherein the panel is disposed within the top basket area of the shopping cart such that the panel forms an enclosure within the top basket area of the cart, the bottom surface of the panel being located within the enclosure and the top surface of the panel being external to the enclosure.
